(19) United States
(12) Patent Application Publication
(10) Pub. No.: US 2020/0128811 A1
(43) Pub. Date: Apr. 30, 2020

(54) Mouse House

(71) Applicant: Linton Ray Evans, Greenville, TX (US)

(72) Inventor: Linton Ray Evans, Greenville, TX (US)

(21) Appl. No.: 16/670,450

(22) Filed: Oct. 31, 2019

Related U.S. Application Data
(60) Provisional application No. 62/753,661, filed on Oct. 31, 2018.

(51) Int. Cl. A01M 23/00; A01M 23/16

(52) U.S. Cl. CPC A01M 23/005; A01M 2200/00; A01M 23/16

(57) ABSTRACT

The present invention discloses a mouse house coated with an adhesive to trap a mouse or rats. The mouse house comprises a flat sheet and end sections or stands. The flat sheet could be quickly curled into a tube. The end sections are configured to provide support to the tube of the mouse house. The flat sheet further comprises an adhesive at the center portion to trap the mouse inside the tube. If a mouse or a rat enters into a tunnel or passageway of the mouse house, it will get stick to the adhesive on the surface of the flat sheet or tube of the mouse house. The user could dispose the trapped or dead mouse along with the tube in the trash without seeing or touching it.

### BACKGROUND OF THE INVENTION

### A. Technical Field

The present invention generally relates to a mouse trap. More specifically, the present invention relates to a mouse house coated with an adhesive to trap a mouse or rats.

### B. Description of Related Art

Mice, although small, could still cause much damage. They destroy articles such as food, books, furniture and even appliances with their gnawing, urine and feces. The mouse could cause many diseases including the hantavirus and that could lead to the more severe hantavirus pulmonary syndrome a respiratory condition that could be fatal. The mice could also spread a variety of organisms that could cause diseases to humans. The mouse otherwise known as the Mus musculus is probably one of the best-known species of rodent. The mice differ from rats in that they are substantially smaller in size. Mice and rats could be particularly difficult to eliminate or avoid since they tend to burrow and could pass through tiny openings. Rats are not usually associated with invasion of homes and businesses to the level that mice are able to penetrate even the most secure structure.

The trapping of mice from structures has been a problem that has plagued humans ever since the first structures were erected near its dwelling place, including caves. Mice are opportunists and like to enter structures where they could find food and safe, warm, and dry places to breed. A person or a user could be struggled for trapping and eliminating the mice or rats from the home or business by using different methods of killing or trapping. When several mice are involved, it may not be possible or feasible to catch and release all the mice or rodents.

The trapping of mice using standard trapping methods presents different issues of disposal of the carcasses for the people. Spring traps are used to kill by impacting the mouse with steel spring-loaded steel or plastic. The spring traps are effective and usually kill immediately although, it does leave the dead mouse or carcasses on the trap, so often the trap has to be disposed of promptly. If not readily disposed of the rotting carcass could smell and attract other unwanted vermin or insects. Spring traps, poison, glue traps, and various other types including live traps all leave the user with the issue of disposing of either the live mouse or a dead one. Disposing of captured or dead mice is an unavoidable consequence of trapping mice and the less a person has to deal with the better results.

Currently, there are hundreds of iterations of rodent traps. Almost all of them are spring loaded with mechanisms that snap down on the mice and kill it. Most of these traps are too expensive to discard, so the user has to remove the dead mouse from the trap and dispose it in the trash. Then, they have to reload the bait and cock the trap. The dead mouse may contain insects and other micro-organisms that could get on the user's hands, which have to be decontaminated. Household pets often try to reach the bait on the traps and could be injured as the trigger the trap or could be contaminated with the insects or micro-organisms departing the dead animal or mice.

In addition, poison style traps are also very popular. There are two problems with these traps. After being poisoned, the pest often retires to their nests and after dying, emit noxious odors. These locations are typically in hard to reach places, so the user simply has to wait it out. The second reason is that household pets could be poisoned and die if they eat a lot of the bait. To circumvent these problems, mouse traps are often employed instead of poisoned baits. So, there is a need to provide a trap to dispose the poisoned mouse into the trash or garbage without the unpleasant odor upon the death of the mouse.

Therefore, there is a need for a mouse house to avoid spreading of diseases into the environment from the dead mice or rats. There is also a need to provide a mouse house to dispose of the dead mouse without ever seeing or touching the trapped mouse. The insects and other micro-organisms of the dead mouse couldn't get on the user's hands and prevent from diseases. Further, there is also a need to provide a mouse house to avoid the unpleasant odor from the dead mouse.

### SUMMARY OF THE INVENTION

The present invention generally discloses a mouse trap. Further, the present invention discloses a mouse house coated with an adhesive to trap a mouse or rats.

According to the present invention, the mouse house is an innovative rodent or mouse trapping product. The mouse house has been designed to retain a mouse inside a tube. In one embodiment, the mouse house could be made of a material, but not limited to, a sturdy and biodegradable chipboard. In one embodiment, an adhesive could be applied substantially to the surface of the mouse house excluding the edges. The mouse house comprises a flat sheet that is quickly curled into a tunnel or tube shape. In one embodiment, the chipboard has a thickness of about 0.022″. If a mouse or a rat enters into a tunnel or passageway of the mouse house, it will get stick to the adhesive or glue agent on the surface of the flat sheet or tube of the mouse house.

In one embodiment, the mouse house comprises a flat chipboard that is quickly curled into the tube shape and at least two end sections or stands. The flat sheet or tube of the mouse house could be coated with a cross pattern of adhesive. In one embodiment, the two stands are configured to provide support on both ends of the tube of the mouse house. On each end of the tube, the end sections or stands could lift the tube off the surface slightly. Both ends of the tube remain open for the mouse or rat to enter from either direction. In one embodiment, the user could place a bait inside the tube via the bait hole by removing the bait cover. The bait inside the tube could attract the mouse and trapped within the mouse house. The user could dispose of the dead mouse in the trash without ever seeing or touching the trapped mouse.

The flat sheet or tube with the bait hole in the middle is subjected to a robotic spreader that lays on a thin layer of the permanently tacky polymeric adhesive. Over this adhesive, the two sections of the silicone treated paper are positioned to shield the adhesive and prevent it from bonding to anything until the mouse house is set up. The flat sheet is inverted and the repositionable adhesive is sprayed around the bait hole. The bait hole could be covered by the bait cover so it could be partially removed, the bait inserted into the trap, and then the cover is pressed back down onto the tube. Finally, the flat sheet or center section and two end pieces are gathered together and placed in the point-of-sale bag with a cardboard pre-printed header pin hanger.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a perspective view of a mouse house for trapping a mouse in an embodiment of the present invention.

FIG. 2 shows a top perspective view of a mouse house in an embodiment of the present invention.

FIG. 3 shows an exploded view of a mouse house in an embodiment of the present invention.

FIG. 4A shows an assembling process of the mouse house in an embodiment of the present invention.

FIG. 4B shows an assembling process of the mouse house in an embodiment of the present invention

FIG. 4C shows an assembling process of the mouse house in an embodiment of the present invention.

FIG. 5A shows a top view of the flat sheet or tube of the mouse house in an embodiment of the present invention.

FIG. 5B shows a side view of the flat sheet or tube of the mouse house in an embodiment of the present invention.

FIG. 6A shows a front view of the end section or stand in an embodiment of the present invention.

FIG. 6B shows a side view of the end section or stand in an embodiment of the present invention.

FIG. 7A shows a front view of the mouse house in an embodiment of the present invention.

FIG. 7B shows a side view of the mouse house in an embodiment of the present invention.

FIG. 7C shows a side view of the tube of the mouse house in an embodiment of the present invention.

FIG. 8A shows a perspective view of a mouse trapped in the mouse house in an embodiment of the present invention.

FIG. 8B shows a perspective view of a mouse stuck or trapped in the tube of the mouse house in an embodiment of the present invention.

FIG. 8C shows a mouse trapped in the tube of the mouse house in an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

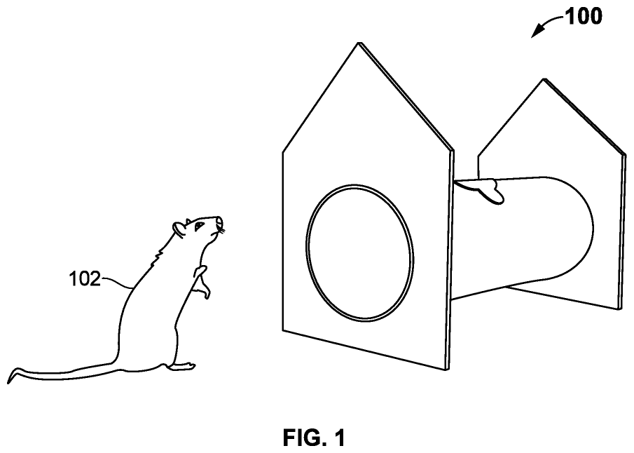

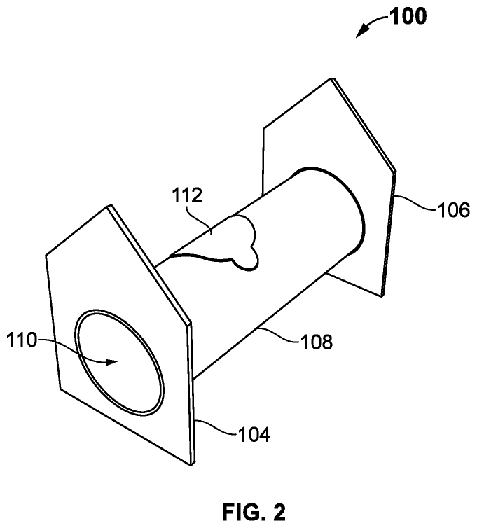

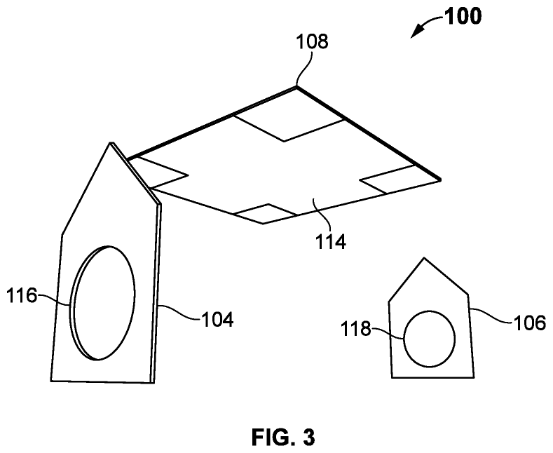

Referring to FIG. 1, the perspective view of a mouse house 100 for trapping a mouse 102 is illustrated. In one embodiment, the mouse house 100 is an innovative rodent or mouse trapping product. The mouse house 100 has been designed to adhesively retain a mouse inside a tube 108 out of sight. In one embodiment, the mouse house 100 could be made of a material, but not limited to, a sturdy and biodegradable chipboard. In one embodiment, an adhesive could be applied substantially on the surface of the mouse house 100 excluding the edges. The mouse house 100 comprising a flat sheet 108 (shown in FIG. 3) form that is quickly curled into a tunnel or tube shape. In one embodiment, the chipboard has a thickness of about 0.022″ and it will support up to 16 ounces when rolled into the tube. In one embodiment, the mouse house 100 could be placed at, but not limited to, a house, office, at the floor and ceiling in the area such as stores and warehouses. After placing the mouse house 100, the mouse or a rat 102 could be entered into a tunnel or passageway 110 (shown in FIG. 2) of the flat sheet or tube 108 (shown in FIG. 3) and sticks to an adhesive agent applied to the surface of the flat sheet or tube 108 (shown in FIG. 3).

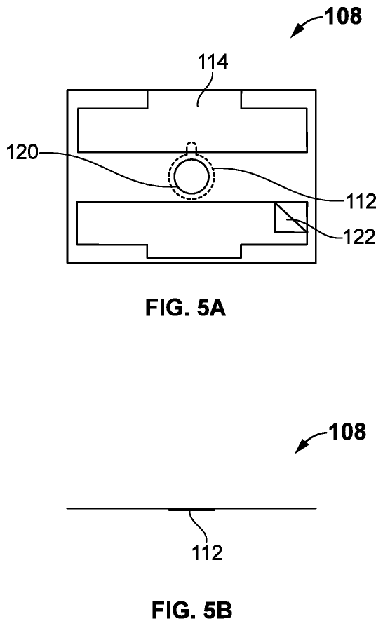

Referring to FIG. 2, the top perspective view of the mouse house 100 is illustrated. In one embodiment, the mouse house 100 could be shipped and stored in a flat configuration that could be easily assembled and put to use immediately. In one embodiment, the mouse house 100 comprises a flat chipboard that is quickly curled into the tube shape and at least two stands (104 and 106). The flat sheet or tube 108 of the mouse house 100 could be coated with a cross pattern of adhesive 114 (shown in FIG. 3). In one embodiment, the two stands (104 and 106) are configured to provide support on both ends of the tube 108 of the mouse house 100. On each end of the tube 108, the stands (104 and 106) could lift the tube 108 off the surface slightly. Both ends of the tube 108 remain open for the mouse or rat 102 to enter from either direction. In one embodiment, the user could place a bait inside the tube 108 via the bait hole 120 (shown in FIG. 5A) by removing the bait cover 112. The bait inside the tube 108 could attract the mouse 102.

Referring to FIG. 3, the exploded view of the mouse house 100 is illustrated. In one embodiment, the plurality of stands (104 and 106) of the mouse house 100 are removably attached to the tube 108. The stand 104 further comprises a hole 116 and another stand 106 comprises a hole 118. The holes (116 and 118) are relieved with slits to allow easy insertion and retention of the tube 108 upon assembly.

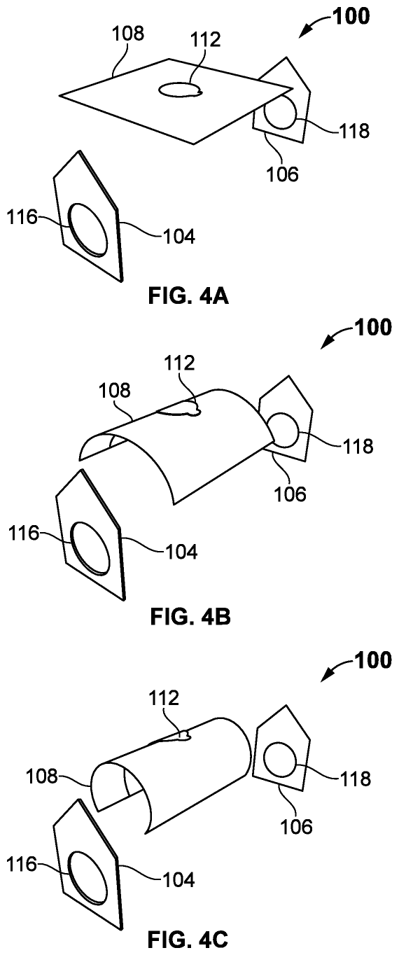

Referring to FIGS. 4A-4C, the perspective views of an assembling process of the mouse house 100 is illustrated. In one embodiment, the mouse house 100 is available on the retail outlet shelves in the flat form. The chipboard sheets or paper has 0.022″ thickness and it is supplied to the die cutting machine in large rectangular sheets, which are pre-printed with a logo. The sheets are automatically fed into the die cutter and the trap components are cut to shape. After cutting, the various components are separated and stacked together. The end pieces (104 and 106) are completed and set aside. The flat sheet or tube 108 with the bait hole 120 (shown in FIG. 5A) in the middle is subjected to a robotic spreader that lays on a thin layer of the permanently tacky polymeric adhesive 114 (shown in FIG. 5A). Over this adhesive 114 (shown in FIG. 5A), the two sections of the silicone treated paper 122 (shown in FIG. 5A) is positioned to shield the adhesive 114 (shown in FIG. 5A) and prevent it from bonding to anything until the mouse house 100 is set up. The flat sheet 108 is inverted and the repositionable adhesive is sprayed around the bait hole 120 (shown in FIG. 5A). The bait hole 120 (shown in FIG. 5A) could be covered by the bait cover 112 so it could be partially removed, the bait inserted into the trap, and then the cover 112 is pressed back down onto the tube 108. Finally, the flat sheet or center section 108 and two end pieces (104 and 106) are gathered together and placed in the point-of-sale bag with a cardboard pre-printed header pin hanger.

The central section of the flat sheet or tube 108 is coated with an adhesive 114 (shown in FIG. 3) and protected with a silicone treated paper shield/peel-off protective shield 122 (shown in FIG. 5A). The silicone treated paper shield 122 (shown in FIG. 5A) could be removed from the adhesive 114 (shown in FIG. 3) before folding into the tube. After removing the silicone treated paper shield 122 (shown in FIG. 5A) from the adhesive 114 (shown in FIG. 3), the flat sheet 108 could be rolled into the tube. The user could place or insert the tube 108 into the holes (116 and 118) of the end sections or stands (104 and 106). In one embodiment, the one end of the tube 108 is inserted into the one end section or stand 104 via the hole 116 and another end of the tube 108 is inserted into another section or stand 106 via the hole 118. The inexpensive product could be deployed almost anywhere and provide high efficiency.

Referring to FIG. 5A, the top view of the flat sheet or tube 108 of the mouse house 100 is illustrated. In one embodiment, the flat sheet or tube 108 could be coated with the cross pattern of adhesive 114. In one embodiment, the cross pattern of adhesive 114 could be covered with a backing or peel-off paper 122. The backing or peel-off paper 122 could be easily removed from the cross pattern of adhesive 114 before use. The cross pattern of adhesive 114 could be, but not limited to, a permanently tacky polymeric adhesive. The cross pattern of adhesive 114 could tightly grip the animal's or mouse's 102 (shown in FIG. 1) feet. The adhesive 114 is set back to allow the mouse 102 (shown in FIG. 1) in the tunnel or passageway 110 to walk toward the bait before being captured or trapped. The adhesive 114 meets when the flat sheet 108 is rolled and covers the lower ⅔^{rd} of the tube for optimum capture capability. In one embodiment, after rolling, the flat sheet 108 could be taped to retain the tube shape. In one embodiment, the adhesive 114 is shaped to provide a walkway for the mouse or rodent to go farther into the tube 108 before the trap. This makes sure the adhesive 114 held closer to the center of the tube 108 so it is not near to either ends for an easier disposal.

Referring to FIG. 5B, the side view of the flat sheet or tube 108 of the mouse house 100 is illustrated. In one embodiment, the flat sheet or tube 108 provided with a bait hole 120. The bait hole 120 could be covered via a bait cover or a tab 112. In one embodiment, the bait cover 112 is configured to cover the bait hole 120 of the flat sheet or tube 108. In one embodiment, a repositionable adhesive is sprayed around the bait hole 120. The repositionable adhesive holds the bait cover 112 so it could be partially removed, the bait inserted into the tube 108, and then covered the bait hole 120 with the bait cover 112 by pressing back down onto the tube 108.

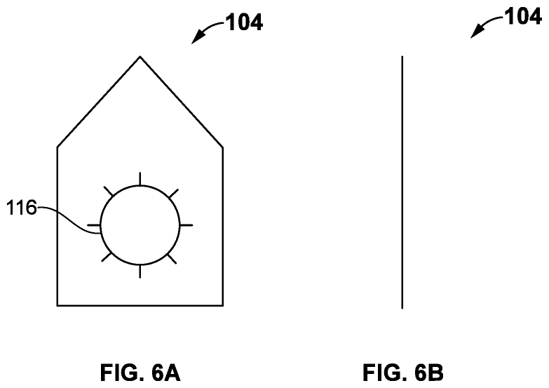

Referring to FIGS. 6A and 6B, the front and side views of the end section or stand 104 is illustrated. In one embodiment, the end section of stand 104 could be provided with a hole 116. The hole 104 has a circular shape. The end pieces or stands (104 and 106) are stamped to a shape is typical die cutter and two are supplied in each package. The hole 116 is relieved with slits to allow easy insertion and retention of the tube 108 (shown in FIG. 2) upon assembly. The end section or stand 104 holds the tube up off the floor and protects it from unwanted intrusion by other pests. Mice are very agile and could easily access the tube 108 via the tunnel or passageway 110 to get the bait.

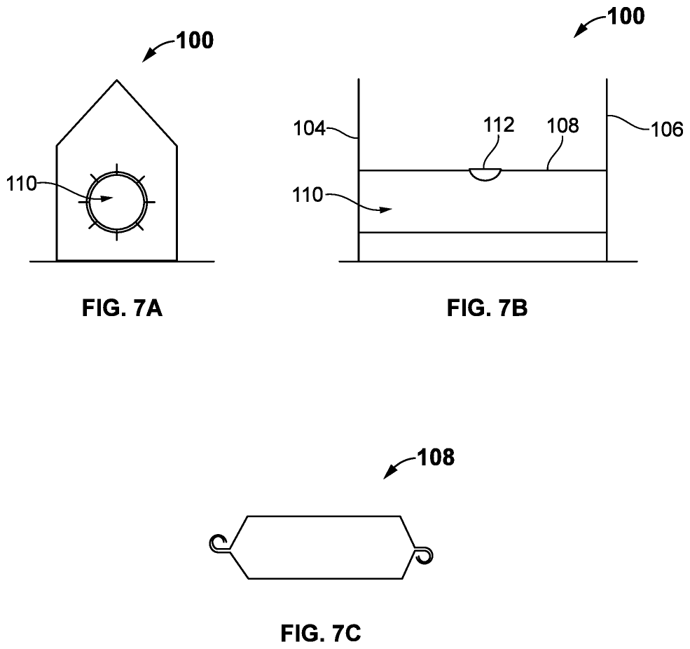

Referring to FIG. 7A, the front view of the mouse house 100 is illustrated. In one embodiment, the mouse house 100 shape helps to define the product and make it different in a crowded market. The tube 108 provides rigidity to the assembly after insertion and could support up to 16 ounces without degradation. Typical mice are 1.0 to 1.5 ounces in weight. Referring to FIG. 7B, the side view of the mouse house 100 is illustrated. In one embodiment, the bait cover or tab 112 is secured to the tube 108 in the flat form using repositionable adhesive and is pulled up to drop the bait into to the tube 108 for trapping the mice. After placed the bait inside the tube 108, the bait cover or tab 112 could be pressed down to seal the hole 120 of the tube 108. The bait in the tube 108 could attract the rodent to move inside the tube 108. In another embodiment, the bottom edges of the tube 108 supports are scored but not bent. These scoring lines allow the bottom edge of the capture tube 108 to be lowered closer to the floor by simply bending the bottom edge of the support to be folded over. The score lines just make it easier to fold and allow the bend to be parallel to the edge.

Referring to FIG. 7C, the side view of the tube 108 of the mouse house 100 is illustrated. If the mouse 102 (shown in FIG. 1) is trapped, the tube 108 could be removed from the end sections or stands (104 and 106). After removing the tube 108 from the stands (104 and 106), the ends of the tube 108 could are rolled up or twisted and could be disposed of in the trash. The mouse house 100 could be placed almost anywhere where the rodents have paths and the user does not have to worry about any pets triggering them.

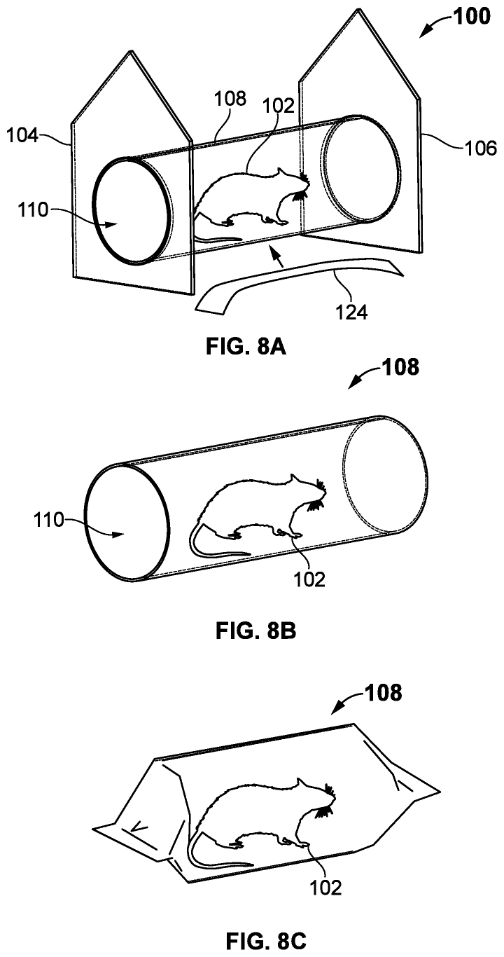

Referring to FIG. 8A, the perspective view of a mouse 102 trapped in the mouse house 100 is illustrated. As the mouse or rodent 102 goes in to get the bait inside the tube 108, then the adhesive 114 (shown in FIG. 3) catches the mouse or rodent 102. Once the mouse or rodent 102 is stuck to the adhesive 114 (shown in FIG. 3) then it cannot escape from the tube 108 of the mouse house 100. The tube 108 has capable to stand on the end sections or stands (104 and 106) without any degradation. In one embodiment, the bottom of the tube 108 could be secured via a tape or sticker 124. The tape or sticker 124 secures the long seam of the tunnel 110 on the bottom of the tube 108. Referring to FIG. 8B, the perspective view of a mouse stuck in the tube 108 of the mouse house 100 is illustrated. If the mouse or rodent 102 is stuck in the tube 108 via the adhesive 114, the user could easily remove the tube 108 from the end sections or stands (104 and 106).

Referring to FIG. 8C, the perspective view of the tube 108 twisted or rolled ends are illustrated. In one embodiment, the user could twist or roll both ends of the tube 108 once it is removed from the end sections or stands (104 and 106). After twisting the ends of the tube 108, the user could be disposed of the tube 108 with the dead mouse 102 into the trash. The mouse house 100 allows the user to dispose of the dead mouse without using hands. The flat end sections or stands (104 and 106) are placed in the recycle bin to reduce the impact on the environment. Then the user acquires another trap, sets it up, and waits for the next capture.

The mouse house 100 is designed to be aesthetic and effective in the application. The relative ease of manufacture and the inexpensive components provide good marketability for the manufacturer. The user benefits from improved application and easy disposal of the captured pest, which provides considerable market interest in the product.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A mouse house for trapping rodents, comprising:
a flat sheet configured to twist into a tube, wherein the tube having open ends on both sides, thereby enabling the rodents to enter into the tube, wherein the interior surface and walls of the tube is coated by an adhesive agent;
at least two stands comprise an opening in its center region, configured to receive and support both ends of the tube.

2. The mouse house of claim 1, is made of a sturdy and biodegradable chipboard.

3. The mouse house of claim 1, wherein the tube comprises a hole on a top portion, wherein the hole is configured to enable a user to place a bait inside the tube for attracting and trapping the rodents.

4. The mouse house of claim 1, further comprises a cover, removably affixed to the hole on the top portion of the tube.

5. The mouse house of claim 1, wherein the adhesive agent is covered by a peel-off protective shield.

6. The mouse house of claim 5, wherein the peel-off protective shield is configured to protect the adhesive agent until just prior to installation of the mouse house.

7. The mouse house of claim 5, wherein the peel-off protective shield is a silicone treated paper shield.

8. The mouse house of claim 1, wherein the adhesive agent is applied on the interior surface and walls of the flat sheet in a cross pattern.

9. The mouse house of claim 1, wherein the adhesive agent is a permanently tacky polymeric adhesive.

10. A mouse house for trapping rodents, comprising:
a flat sheet configured to twist into a tube, wherein the tube having open ends on both sides, thereby enabling the rodents to enter into the tube, wherein the interior surface and walls of the tube is coated by an adhesive agent, said adhesive agent is covered by a peel-off protective shield;
wherein the tube comprises a hole on a top portion, wherein the hole is configured to enable a user to place a bait inside the tube for trapping the rodents, and
at least two stands comprise an opening in its center region, configured to receive and support both ends of the tube.

11. The mouse house of claim 10, is made of a sturdy and biodegradable chipboard.

12. The mouse house of claim 10, further comprises a cover, removably affixed to the hole on the top portion of the tube.

13. The mouse house of claim 10, wherein the peel-off protective shield is configured to protect the adhesive agent until just prior to installation of the mouse house.

14. The mouse house of claim 10, wherein the peel-off protective shield is a silicone treated paper shield.

15. The mouse house of claim 10, wherein the adhesive agent is applied on the interior surface and walls of the flat sheet in a cross pattern.

16. The mouse house of claim 10, wherein the adhesive agent is a permanently tacky polymeric adhesive.
